(19) United States
(12) Patent Application Publication
(10) Pub. No.: US 2026/0153858 A1
(43) Pub. Date: Jun. 4, 2026

(54) ARTIFICIAL INTELLIGENCE-DRIVEN AUTOMATION SYSTEM FOR CRITICAL INFRASTRUCTURE PROTECTION COMPLIANCE IN BULK ELECTRIC POWER SYSTEMS

(71) Applicant: Rajender Reddy PELL REDDY, Glen Allen, VA (US)

(72) Inventor: Rajender Reddy PELL REDDY, Glen Allen, VA (US)

(21) Appl. No.: 19/457,291

(22) Filed: Jan. 23, 2026

(51) Int. Cl. G05B 19/418

(52) U.S. Cl. CPC G05B 19/4184; G05B 19/4185

(57) ABSTRACT

An artificial intelligence-driven automation system for Critical Infrastructure Protection compliance in bulk electric power systems includes a machine-based compliance control apparatus having a processing unit, a non-transitory memory unit, and a communication interface unit that receives real-time operational state data, access activity data, configuration state data, and security event data from regulated power system assets and supporting systems. Trained artificial intelligence models stored in the memory unit are executed by the processing unit to correlate observed system states with predefined compliance control requirements and to determine a real-time compliance state for each regulated asset. Upon detection of a compliance deviation or predicted non-compliance risk, compliance enforcement actions are automatically initiated, including access restriction, configuration restoration, and communication path isolation, and verifies restoration of compliance through post-enforcement evaluation. Tamper-resistant compliance evidence records bound to time-synchronized timestamps and asset identifiers are generated, thereby enabling continuous audit readiness and proactive compliance management.

### TECHNICAL FIELD OF THE INVENTION

The present invention relates generally to the field of electric power system security, compliance automation, and intelligent monitoring, and more particularly to an artificial intelligence-driven automation system implemented as a machine-based apparatus for enforcing, validating, and continuously maintaining Critical Infrastructure Protection compliance within bulk electric power systems. The invention lies at the intersection of power system engineering, cybersecurity governance, automated compliance verification, and artificial intelligence-assisted operational control for high-reliability electrical infrastructure.

### BACKGROUND OF THE INVENTION

Bulk electric power systems constitute the backbone of modern industrial, commercial, and residential energy distribution, and any disruption to their availability, integrity, or reliability can result in cascading economic, safety, and national security consequences. To mitigate such risks, regulatory frameworks governing Critical Infrastructure Protection impose stringent requirements on asset identification, access control, monitoring, logging, incident response, vulnerability assessment, and audit readiness across generation, transmission, and control infrastructures. Existing compliance practices in bulk electric power systems are largely manual or semi-automated, relying on static rule interpretation, periodic audits, human-driven documentation, and fragmented monitoring tools that operate independently of one another.

Conventional compliance management systems typically function as document-centric repositories or checklist-based platforms that require extensive manual input, periodic data reconciliation, and subjective interpretation of regulatory requirements. Such systems are incapable of responding dynamically to real-time operational changes occurring within substations, control centers, supervisory control and data acquisition environments, intelligent electronic devices, and communication networks that collectively constitute the bulk electric power system. As a result, compliance posture is often evaluated retrospectively rather than continuously, leaving temporal gaps during which non-compliant or insecure conditions may persist undetected.

Furthermore, existing cybersecurity monitoring tools deployed within power systems focus predominantly on threat detection or network intrusion, without correlating detected events to specific compliance obligations or regulatory controls. This disjointed approach leads to a lack of contextual awareness, where operators may detect anomalous behavior but cannot immediately assess its compliance impact or regulatory severity. Similarly, compliance audit preparation remains an onerous task, requiring manual aggregation of logs, access records, configuration snapshots, and procedural evidence from disparate sources.

The absence of intelligent correlation, predictive risk analysis, and automated enforcement mechanisms results in increased operational overhead, higher compliance costs, delayed remediation, and elevated risk exposure. There exists a need for a unified, machine-based system capable of continuously ingesting operational data from bulk electric power assets, interpreting regulatory compliance requirements in real time, autonomously evaluating system states against those requirements, and initiating corrective or preventive actions without human intervention. The present invention addresses these deficiencies by introducing an artificial intelligence-driven automation system embodied as a dedicated compliance enforcement device integrated directly into bulk electric power system environments.

Bulk electric power systems operate as tightly coupled cyber-physical environments in which supervisory control and data acquisition networks, energy management systems, protection relays, programmable automation controllers, intelligent electronic devices, time-synchronization sources, and field communications collectively maintain grid stability. Because these assets are foundational to reliable generation and transmission, critical infrastructure protection compliance programs require utilities and operators to identify and categorize assets, control and log access, maintain secure configurations, manage vulnerabilities, and produce evidence showing that such controls are continuously maintained. In practice, the compliance objective is not merely to deploy security tooling, but to demonstrate that the tooling, processes, and technical states of operational technology assets meet prescribed requirements over time and across system changes. The technical background therefore involves both cybersecurity monitoring and compliance assurance, and in bulk electric power environments these two domains have historically been implemented through separate toolchains with limited real-time interoperability.

A common existing approach is the use of governance, risk, and compliance software that acts as a central repository for policy documents, checklists, control mappings, and audit workflows. These systems often provide templates and reporting functions, and may integrate with ticketing systems for remediation tracking. However, they are primarily designed for enterprise information technology environments rather than operational technology networks, and they generally rely on periodic, manual evidence collection and human attestation. In bulk electric power systems, many compliance-relevant events occur in time windows shorter than audit cycles, such as temporary access changes, emergency remote sessions, or short-lived configuration deviations caused by maintenance or failover. Document-centric compliance platforms typically cannot ingest the granular telemetry and device state information needed to prove continuous compliance, and they cannot reliably interpret specialized operational technology protocols or device logs without extensive custom integration. This leads to gaps where compliance status is inferred rather than measured, and where the stored evidence reflects what operators believe occurred rather than what the system actually enforced in real time.

Security information and event management systems represent another widely deployed solution used to centralize logs and generate alerts. A security information and event management platform can ingest event streams from firewalls, authentication servers, endpoint agents, and sometimes industrial intrusion detection sensors, and can correlate events using rule-based logic. While such platforms improve visibility, they are typically optimized for high-volume enterprise log analytics rather than deterministic operational technology behavior. In bulk electric power networks, many devices emit sparse, proprietary, or irregular logs, and some critical devices cannot run endpoint agents. Additionally, security information and event management correlation rules are often brittle and require constant tuning to minimize false positives and false negatives. Most importantly, the alerts produced are usually framed in security terms rather than compliance terms; an analyst may receive an alarm for an anomalous connection but still need to manually map it to whether a specific compliance control was violated, whether the event affected a regulated asset category, and what evidence must be preserved for audit. This manual translation introduces delays and inconsistency, and it increases the probability that compliance impact is under-or over-estimated.

Another set of existing solutions includes industrial intrusion detection systems and network detection products tailored to operational technology. These systems passively monitor network traffic, build baselines of expected communication patterns, and flag deviations such as new devices, unusual protocol commands, or suspected reconnaissance. They are valuable for detecting certain classes of threats without placing active software on fragile devices. However, baseline-based detection can be unstable in power environments where legitimate operational changes occur, such as seasonal switching patterns, emergency topology reconfiguration, firmware upgrades, or vendor maintenance. These conditions can trigger alarm storms that overwhelm operators, causing alert fatigue and reduced trust. Moreover, industrial intrusion detection systems generally do not enforce compliance; they observe and alert, but they do not automatically reconcile detected changes with approved configurations, access authorizations, or evidence requirements. As a result, these systems enhance situational awareness but still require extensive manual work to determine whether an observed deviation constitutes a compliance violation, a permitted change, or a transient operational necessity.

Configuration management databases and asset inventory tools are also used to support compliance by tracking hardware and software inventories, firmware versions, network addresses, and ownership information. In enterprise environments, automated discovery and endpoint management can maintain relatively complete inventories. In bulk electric power systems, discovery is constrained by strict change-control practices, segmented networks, and the need to avoid scanning techniques that may disrupt sensitive devices. Consequently, inventories can become stale, incomplete, or inconsistent across sites. Even when inventory data is accurate, many tools treat asset attributes as static records rather than dynamic compliance variables. Compliance often depends on time-bounded conditions such as patch windows, credential rotation periods, remote access session durations, and incident response timelines. Traditional inventory solutions do not continuously evaluate these temporal constraints against real-time system events, which results in compliance being checked episodically rather than continuously. This episodic checking can miss violations that occur and self-resolve between audit snapshots, which is problematic because both risk exposure and evidentiary integrity depend on continuous coverage.

Vulnerability management tools and patch management platforms are frequently cited as compliance enablers because they can identify missing patches and known weaknesses. In operational technology environments, however, patching is often constrained by vendor certification requirements, limited maintenance windows, system availability obligations, and the risk that a patch may affect deterministic behavior. Many vulnerability scanners rely on active probing or authenticated scanning, which may not be feasible on isolated or safety-critical segments. Even passive vulnerability identification can be limited because industrial devices may not disclose software bill of materials information or may use customized firmware. Patch management platforms typically assume homogeneous operating system fleets, while bulk electric power environments contain a heterogeneous mix of embedded devices, specialized appliances, and legacy systems. The drawback is that vulnerability posture cannot always be measured precisely, and when it can be measured, the remediation path is not always immediate or straightforward. Compliance programs then rely on compensating controls and documentation, which again shifts the burden to manual processes.

Access control and privileged access management solutions are another major category used to enforce and log who accessed what systems and when. In critical infrastructure settings, remote access gateways, jump hosts, multi-factor authentication systems, and session recording tools are deployed to constrain interactive access. These solutions can generate strong logs and may reduce unauthorized access risk. However, they are often deployed as isolated layers that do not integrate tightly with device configuration states, network segmentation changes, or operational events. For example, an access management system may record that a user initiated a session, but it may not capture whether configuration changes were made on regulated devices, whether those changes were approved, or whether they align with baseline settings required for compliance. Session recordings are also costly to store and review, and they are rarely analyzed in real time. The compliance process still depends on auditors or internal teams manually sampling sessions, correlating them with change tickets, and assembling evidence packages.

Automation initiatives in the compliance space frequently take the form of scripts, playbooks, or workflow automation using orchestration products. These can reduce repetitive tasks such as collecting logs, generating reports, or opening remediation tickets. The drawback is that script-based automation is typically fragile, environment-specific, and difficult to maintain across diverse sites and evolving infrastructure. Bulk electric power systems often contain air-gapped segments, vendor-specific interfaces, and strict operational constraints that cause automation to fail unpredictably. Additionally, orchestration playbooks usually encode compliance logic as static rules. Static rules can be insufficient when compliance determinations depend on context, such as whether an asset is within a particular electronic security perimeter, whether an event occurred during an emergency operating state, or whether a device is in a maintenance mode authorized under specific procedures. Rule-based automation is also prone to becoming outdated when standards evolve, when asset categorizations change, or when architectures are modernized.

More recent offerings incorporate artificial intelligence or machine learning for anomaly detection and log analytics. These tools may classify events, cluster similar behaviors, or prioritize alerts. While they promise improved detection, they often operate as add-ons to existing security monitoring pipelines rather than as compliance-specific automation systems. Many machine learning models are trained on generic cybersecurity datasets that do not represent operational technology command patterns or bulk electric power operational constraints, which can lead to misclassification. Machine learning systems also introduce explainability and evidentiary issues: compliance programs often require defensible reasoning for why an event is labeled as a violation and what control mapping applies. If an artificial intelligence output cannot be translated into a reproducible compliance rationale, it may be unsuitable for audits or may require extensive human validation, diminishing the automation benefit.

A recurring drawback across these existing solutions is the lack of an integrated, continuous, and enforceable compliance posture that bridges operational telemetry, security events, asset context, regulatory control mapping, and audit-grade evidence. Current ecosystems tend to provide pieces of the puzzle—visibility without enforcement, documentation without real-time measurement, or alerting without compliance correlation. This fragmentation forces operators to stitch together compliance narratives from multiple systems, increasing the probability of inconsistency and missed violations. It also leads to delayed remediation because identifying a compliance gap typically requires human interpretation, cross-tool correlation, and manual approvals, during which time the underlying non-compliant condition may persist. In bulk electric power systems where reliability and security are paramount, these limitations motivate the need for a machine-based system that can continuously interpret compliance requirements, evaluate real-time states, initiate corrective actions under controlled policies, and generate tamper-resistant evidence suitable for audits while respecting operational constraints of critical infrastructure environments.

### SUMMARY OF THE INVENTION

The invention provides an artificial intelligence-driven automation system implemented as a machine-based apparatus configured to continuously monitor, analyze, enforce, and document Critical Infrastructure Protection compliance across bulk electric power systems. The system integrates hardware processing units, secure data interfaces, memory structures, and communication circuitry to form a dedicated compliance control device operatively connected to operational technology assets, cybersecurity sensors, access control systems, and configuration management infrastructure.

The system is configured to ingest real-time telemetry, access logs, configuration parameters, and environmental data from bulk electric power system components and to process such data using trained artificial intelligence models that dynamically map observed system states to predefined compliance control requirements. The device autonomously determines compliance deviations, predicts emerging compliance risks, and initiates automated enforcement actions, including access restriction, configuration rollback, alert escalation, and evidentiary record generation. The system further maintains a continuously updated compliance state ledger that enables real-time audit readiness and regulatory reporting.

The primary object of the present invention is to provide an artificial intelligence-driven automation system implemented as a machine-based apparatus that enables continuous, real-time enforcement and validation of Critical Infrastructure Protection compliance within bulk electric power systems, thereby eliminating reliance on periodic, manual, and retrospective compliance assessments. The invention seeks to ensure that compliance status is determined directly from actual operational states of regulated assets, communication pathways, and access activities rather than inferred from static documentation or human attestations.

Another object of the invention is to provide a unified technical system capable of ingesting heterogeneous operational technology telemetry, cybersecurity event data, access control records, and configuration state information from geographically distributed bulk electric power system components and processing such data through artificial intelligence-based analytical logic to dynamically map observed system behavior to predefined compliance control requirements. The invention aims to overcome the fragmentation of existing solutions by correlating security events, operational changes, and asset context within a single automated compliance determination process.

A further object of the invention is to enable autonomous detection of compliance deviations and emerging non-compliance risks by continuously analyzing real-time and historical system data, and to initiate automated enforcement or mitigation actions through secure machine-to-machine interfaces without requiring human intervention for routine compliance conditions. The invention is intended to reduce response latency, prevent prolonged exposure to non-compliant states, and ensure that corrective actions are executed consistently according to predefined technical and regulatory constraints.

Another object of the invention is to provide a machine-based compliance control device that generates, stores, and maintains cryptographically protected compliance evidence in a tamper-resistant manner, such that audit readiness is preserved at all times and regulatory reporting can be produced directly from system records without manual reconstruction. The invention seeks to ensure evidentiary integrity by binding detected events, evaluated compliance states, and enforcement actions to verifiable timestamps and asset identifiers.

An additional object of the invention is to provide predictive compliance risk assessment by applying artificial intelligence models to historical operational patterns, configuration changes, access behaviors, and system evolution trends in order to forecast potential future compliance violations before they occur. The invention aims to enable proactive remediation and planning, thereby shifting compliance management from a reactive posture to a preventative and anticipatory operational function.

Another object of the invention is to deliver a structurally integrated apparatus designed for deployment within the physical and electromagnetic environments of bulk electric power systems, wherein the apparatus includes hardened processing, secure communication interfaces, environmental protection, and physical tamper detection mechanisms. The invention seeks to ensure reliable, continuous operation of the compliance automation system under the electrical, thermal, and security conditions characteristic of critical power infrastructure facilities.

A further object of the invention is to support scalable deployment across multiple substations, control centers, and operational domains by enabling coordinated operation of multiple compliance automation devices that securely synchronize compliance states, enforcement actions, and evidentiary records while preserving localized operational autonomy. The invention aims to maintain a consistent system-wide compliance posture without introducing single points of failure or centralized bottlenecks.

Another object of the invention is to provide a technically adaptable compliance automation system that can accommodate evolving regulatory requirements, asset categorizations, and system architectures through controlled updates to its artificial intelligence models and compliance knowledge representations, without requiring fundamental redesign of the underlying hardware apparatus. The invention thereby seeks to extend the operational lifetime of the compliance system while maintaining alignment with changing Critical Infrastructure Protection standards and technological advancements in bulk electric power systems.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of an artificial intelligence-driven automation system for Critical Infrastructure Protection compliance in bulk electric power systems

FIG. 2 displays flow chart of a method for artificial intelligence-driven automation of Critical Infrastructure Protection compliance in bulk electric power systems

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

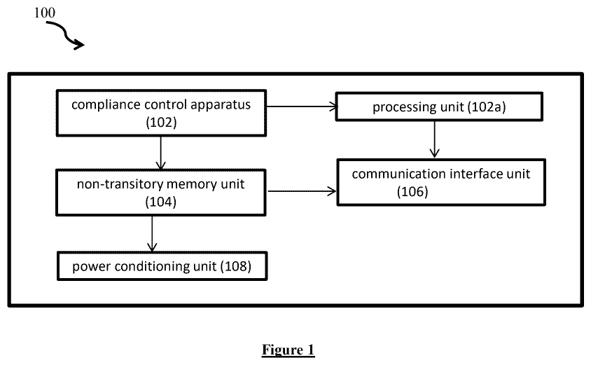

Referring to FIG. 1, a block diagram of an artificial intelligence-driven automation system for Critical Infrastructure Protection compliance in bulk electric power systems is illustrated. The system 100 comprises: a compliance control apparatus (102) deployed within an operational environment of a bulk electric power system; the compliance control apparatus comprising at least one processing unit (102a); a non-transitory memory unit (104) operatively coupled to the processing unit; a communication interface unit (106) configured for bidirectional data exchange with operational technology assets, cybersecurity monitoring devices, access control systems, and configuration repositories associated with the bulk electric power system; and a power conditioning unit (108) configured to maintain uninterrupted operation of the compliance control apparatus during electrical disturbances; wherein the non-transitory memory unit stores machine-executable instructions and trained artificial intelligence models representing compliance control requirements applicable to regulated bulk electric power system assets; wherein the processing unit is configured to continuously receive real-time operational state data, access activity data, configuration state data, and security event data through the communication interface unit; wherein the processing unit is further configured to execute the trained artificial intelligence models to correlate the received data with predefined compliance control conditions and to determine a real-time compliance state for each monitored asset; and wherein the processing unit is configured to initiate automated compliance enforcement actions through the communication interface unit when the determined real-time compliance state indicates a deviation from the predefined compliance control conditions.

In an embodiment, the communication interface unit (104) comprises a plurality of electrically isolated communication ports configured to interface concurrently with supervisory control and data acquisition systems, intelligent electronic devices, protective relay systems, authentication servers, and network security appliances, and wherein the processing unit enforces logical separation between data received from different operational domains prior to compliance evaluation.

In an embodiment, the processing unit (102a) is configured to normalize heterogeneous operational data by converting device-specific telemetry formats, log structures, and event representations into a standardized internal data structure stored in the non-transitory memory unit before execution of the trained artificial intelligence models.

In an embodiment, the trained artificial intelligence models stored in the non-transitory memory unit are configured to evaluate compliance control conditions based on asset category, asset criticality designation, association with an electronic security perimeter, and a current operating state of the bulk electric power system.

In an embodiment, the processing unit (102a) is configured to determine compliance of access activities by correlating authentication credentials, authorization attributes, session initiation time, session termination time, and configuration changes detected on regulated assets during an access session.

In an embodiment, the processing unit (102a) is configured to identify configuration deviations by comparing detected configuration parameters of regulated assets against stored baseline configuration profiles maintained in the non-transitory memory unit.

In an embodiment, the processing unit (102a) is further configured to transmit verified baseline configuration data through the communication interface unit to a regulated asset in response to a detected configuration deviation, and to re-evaluate the post-transmission operational state to confirm restoration of compliance.

In an embodiment, the non-transitory memory unit (104) further stores a compliance evidence repository comprising records that bind detected events, evaluated compliance states, and enforcement actions to time-synchronized timestamps and unique asset identifiers.

In an embodiment, the processing unit (102a) is configured to store compliance evidence records in a write-protected sequence such that modification of previously stored records is detectable during subsequent compliance verification or audit review.

In an embodiment, the processing unit (102a) is configured to perform predictive compliance risk analysis by applying the trained artificial intelligence models to historical compliance state transitions, access behavior patterns, configuration change frequency data, and system topology evolution data stored in the non-transitory memory unit.

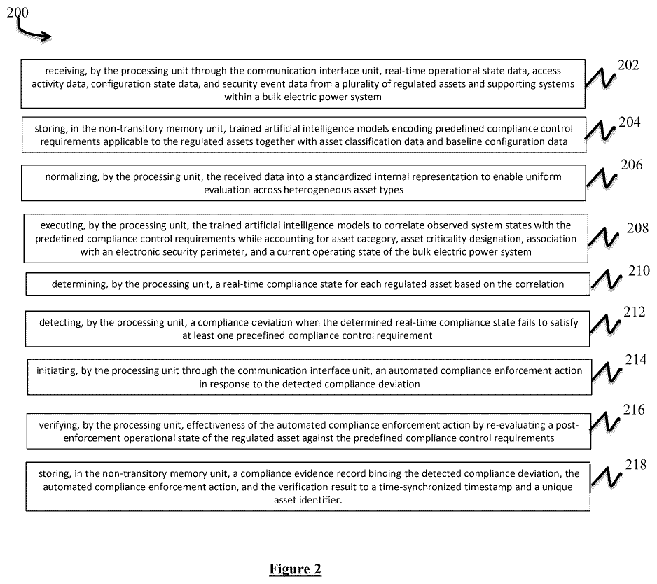

Referring to FIG. 2, a flow chart for a method for artificial intelligence-driven automation of Critical Infrastructure Protection compliance in bulk electric power systems, the method being executed by a compliance control apparatus comprising at least one processing unit, a non-transitory memory unit, and a communication interface unit, the method comprising of is illustrated.

The compliance control apparatus comprises at least one processing unit, a non-transitory memory unit, and a communication interface unit operatively interconnected through a system bus, wherein the processing unit is configured to execute firmware instructions to control data acquisition, normalization, correlation, enforcement orchestration, and verification operations by issuing memory read/write commands to the non-transitory memory unit and network transmission commands to the communication interface unit; the communication interface unit comprises at least one network controller and protocol stack configured to establish persistent telemetry subscriptions with supervisory control and data acquisition systems, intelligent electronic devices, access control servers, configuration management systems, and network security devices using industrial communication protocols, and to receive operational state data, access activity data, configuration state data, and security event data as asynchronous data streams; the processing unit parses and buffers the received data into internal queues, performs field-level mapping and data structure transformation using normalization routines stored in the non-transitory memory unit, generates compliance state frames, executes trained artificial intelligence models stored as executable parameter sets in the non-transitory memory unit, computes compliance state classifications, generates deviation objects, selects enforcement workflows, and transmits remediation commands through the communication interface unit; the non-transitory memory unit stores the trained artificial intelligence models, compliance rule sets, asset classification data, baseline configuration data, enforcement workflows, evidence ledgers, time-indexed compliance datastores, and state transition tables, and provides transactional read/write access to the processing unit; and the communication interface unit further transmits configuration restoration data, access revocation instructions, and network traffic modification commands to external regulated assets and supporting systems and receives acknowledgement messages and post-enforcement telemetry data used by the processing unit to verify remediation execution and update compliance evidence records.

The method 200 comprises:

At step 202, the method 200 includes receiving, by the processing unit through the communication interface unit, real-time operational state data, access activity data, configuration state data, and security event data from a plurality of regulated assets and supporting systems within a bulk electric power system;

At step 204, the method 200 includes storing, in the non-transitory memory unit, trained artificial intelligence models encoding predefined compliance control requirements applicable to the regulated assets together with asset classification data and baseline configuration data;

At step 206, the method 200 includes normalizing, by the processing unit, the received data into a standardized internal representation to enable uniform evaluation across heterogeneous asset types;

At step 208, the method 200 includes executing, by the processing unit, the trained artificial intelligence models to correlate observed system states with the predefined compliance control requirements while accounting for asset category, asset criticality designation, association with an electronic security perimeter, and a current operating state of the bulk electric power system;

At step 210, the method 200 includes determining, by the processing unit, a real-time compliance state for each regulated asset based on the correlation;

At step 212, the method 200 includes detecting, by the processing unit, a compliance deviation when the determined real-time compliance state fails to satisfy at least one predefined compliance control requirement;

At step 214, the method 200 includes initiating, by the processing unit through the communication interface unit, an automated compliance enforcement action in response to the detected compliance deviation;

At step 216, the method 200 includes verifying, by the processing unit, effectiveness of the automated compliance enforcement action by re-evaluating a post-enforcement operational state of the regulated asset against the predefined compliance control requirements; and

At step 218, the method 200 includes storing, in the non-transitory memory unit, a compliance evidence record binding the detected compliance deviation, the automated compliance enforcement action, and the verification result to a time-synchronized timestamp and a unique asset identifier.

In an embodiment, receiving the real-time operational state data comprises acquiring telemetry values, protection status indicators, and control command activity from supervisory control and data acquisition systems and intelligent electronic devices without interrupting primary power system operations.

In an embodiment, receiving the access activity data comprises collecting authentication events, authorization attributes, session initiation records, session termination records, and user identity information associated with interactive and remote access to regulated assets.

In an embodiment, normalizing the received data comprises converting device-specific log formats, protocol representations, and configuration parameter structures into a common internal data structure stored in the non-transitory memory unit prior to execution of the trained artificial intelligence models.

In an embodiment, executing the trained artificial intelligence models comprises evaluating compliance conditions that vary dynamically based on changes in asset classification, changes in electronic security perimeter boundaries, and transitions between normal, maintenance, and emergency operating states.

In an embodiment, detecting the compliance deviation comprises identifying a configuration parameter of a regulated asset that deviates from a stored baseline configuration profile maintained in the non-transitory memory unit.

In an embodiment, initiating the automated compliance enforcement action comprises transmitting verified baseline configuration data from the non-transitory memory unit to the regulated asset through the communication interface unit to restore the regulated asset to a compliant configuration state.

In an embodiment, initiating the automated compliance enforcement action comprises restricting access privileges by transmitting updated authorization control data to an access control system associated with the bulk electric power system.

In an embodiment, initiating the automated compliance enforcement action comprises isolating a communication path by instructing a network security device to modify traffic handling parameters associated with a regulated asset identified as non-compliant.

In an embodiment, verifying effectiveness of the automated compliance enforcement action comprises re-collecting operational state data and configuration state data from the regulated asset and re-executing the trained artificial intelligence models to confirm satisfaction of the predefined compliance control requirements.

In an embodiment, initiating the automated compliance enforcement action comprises transmitting verified baseline configuration data from the non-transitory memory unit to the regulated asset through the communication interface unit to restore the regulated asset to a compliant configuration state, wherein initiating the automated compliance enforcement action comprises restricting access privileges by transmitting updated authorization control data to an access control system associated with the bulk electric power system, wherein initiating the automated compliance enforcement action comprises isolating a communication path by instructing a network security device to modify traffic handling parameters associated with a regulated asset identified as non-compliant, and wherein verifying effectiveness of the automated compliance enforcement action comprises re-collecting operational state data and configuration state data from the regulated asset and re-executing the trained artificial intelligence models to confirm satisfaction of the predefined compliance control requirements.

In this embodiment, once a regulated asset is algorithmically determined to be in a non-compliant operational state, the compliance control apparatus automatically initiates a corrective enforcement cycle that operates as a closed-loop cyber-physical remediation system. The processing unit retrieves a previously validated and cryptographically signed baseline configuration profile corresponding to the specific asset type, firmware version, and regulatory control class from the non-transitory memory unit. This profile is packetized into authenticated control messages and transmitted through the communication interface unit over a secured industrial protocol channel such as IEC 61850 MMS, DNP3 Secure Authentication, or OPC-UA with certificate-based trust. Upon receipt, the regulated asset executes a parameter reconciliation routine in which its active configuration registers, access control tables, security policies, and protocol enablement flags are overwritten with the baseline parameters to eliminate unauthorized changes. For example, if a substation gateway is found to have disabled port-level authentication or altered firewall rules, the transmitted baseline automatically restores the original rule sets, encryption modes, and session timeout values, thereby returning the device to a regulator-approved hardened state.

Simultaneously, the processing unit generates updated authorization control data that dynamically alters access privileges across the bulk electric power system environment. This is achieved by issuing real-time policy update instructions to the centralized or distributed access control system, such as an identity and access management server or role-based control engine. The access control system enforces these updates by revoking elevated privileges, terminating anomalous sessions, and reassigning users to restricted roles based on the detected deviation. For instance, if a remote engineering workstation attempts configuration changes outside an approved maintenance window, the system immediately revokes its modification rights and forces session termination, thereby preventing further non-compliant actions without requiring manual operator intervention.

Where the deviation involves unauthorized communication exposure, the compliance control apparatus performs network-level isolation by identifying the specific data flows associated with the affected regulated asset. Protocol metadata such as source address, destination port, service identifier, and session fingerprint are extracted from the normalized internal representation and used to generate flow-specific control instructions for a network security device, such as an industrial firewall or software-defined network controller. The network security device modifies its traffic handling parameters to block, rate-limit, or reroute only the non-compliant communication path, rather than isolating the entire asset. For example, if a relay protection device is communicating with an unapproved external endpoint, only that connection is terminated while legitimate supervisory traffic is preserved, thereby maintaining operational continuity.

After the enforcement actions are executed, the apparatus immediately enters a verification phase to ensure that the remediation was technically effective. The communication interface unit re-collects live operational telemetry and configuration parameters from the regulated asset, and the processing unit regenerates the internal compliance state representation. The trained artificial intelligence models are re-executed using this post-enforcement data to compute a new compliance classification and control satisfaction metrics. These results are compared with the pre-enforcement state to confirm that all predefined compliance control requirements are now met. This closed-loop verification mechanism provides a measurable and machine-validated confirmation of compliance restoration, representing a significant technical advancement over manual, static, or rule-only remediation systems by enabling autonomous, verifiable, and adaptive enforcement within critical infrastructure environments.

In an embodiment, normalizing the received data comprises: mapping telemetry values, access activity records, configuration parameters, and security event fields into a multi-dimensional compliance state vector, assigning each element of the compliance state vector a semantic label corresponding to a predefined compliance control requirement, associating each element with the unique asset identifier, asset category, and asset criticality designation, and persisting the compliance state vector in the non-transitory memory unit for time-sequenced correlation by the trained artificial intelligence models.

In this embodiment, heterogeneous data streams originating from operational sensors, access management systems, configuration repositories, and cybersecurity monitoring platforms are transformed by the processing unit into a unified machine-interpretable representation that enables deterministic and learning-based compliance evaluation. Raw telemetry values such as voltage, breaker status, protocol error rates, and device health indicators are first decoded into numerical feature elements, while access activity logs, configuration change records, and security alerts are parsed into structured state attributes. These diverse inputs are then projected into a multi-dimensional compliance state space in which each dimension represents a control-relevant condition associated with regulatory requirements, such as authentication enforcement, firmware integrity, encryption activation, role-based access restrictions, or network segmentation status. Each dimension is assigned a semantic label that directly corresponds to a predefined compliance control requirement stored in a regulatory control library, thereby creating an explicit logical mapping between observed system behavior and regulatory obligations.

To provide contextual awareness, every element of the compliance state representation is bound to metadata that identifies the regulated asset, its functional category, and its criticality classification within the bulk electric power system. For example, the same configuration parameter value may be interpreted differently for a protective relay than for a data historian server, and the semantic association enables the system to apply asset-specific compliance thresholds and risk weights. The fully constructed compliance state representation is then persisted in the non-transitory memory unit as a time-indexed object that can be sequenced, compared, and correlated across successive operational intervals. This structured persistence allows the trained artificial intelligence models to analyze temporal behavior patterns, detect abnormal state transitions, and distinguish between transient deviations and sustained violations.

In an embodiment, normalizing further comprises generating a versioned compliance snapshot by time-aligning the compliance state vector with the time-synchronized timestamp, and storing successive compliance snapshots in a chronological compliance state graph representing temporal transitions of each regulated asset, and wherein executing the trained artificial intelligence models comprises traversing the chronological compliance state graph to evaluate transitions between successive compliance snapshots against control transition rules stored in the non-transitory memory unit.

In this embodiment, each normalized compliance state representation is transformed into a versioned compliance snapshot by aligning it with a system-wide synchronized timestamp derived from a trusted time source, such as a GPS clock, NTP-secured time server, or SCADA master clock. The processing unit assigns a monotonically increasing version identifier to each snapshot, ensuring that every recorded compliance condition of a regulated asset can be uniquely referenced and reconstructed. These time-aligned snapshots are persistently stored as sequential nodes within a chronological compliance state graph maintained in the non-transitory memory unit, where each node represents the complete compliance condition of the asset at a specific moment and each edge represents a temporal transition between two states. This graph structure enables the system to retain not only static compliance states but also the historical evolution of the asset's behavior, including configuration drift, repeated access anomalies, or gradual security posture degradation.

When the trained artificial intelligence models are executed, the processing unit does not merely analyze the current snapshot in isolation but traverses the compliance state graph to evaluate transitions between successive nodes. Each transition is compared against predefined control transition rules that define permissible, restricted, or prohibited state changes for each asset class. For example, a rule may specify that a firewall configuration cannot transition from a restricted state to an open state unless a corresponding maintenance authorization event is present in the access logs. If the traversal identifies a transition that violates these rules, the system flags the behavior as a temporal compliance deviation, even if the individual snapshots appear acceptable when viewed independently. This graph-based temporal evaluation provides a significant technical advancement over static compliance checks by enabling the detection of behavioral violations, rollback attacks, configuration oscillation patterns, and stealthy policy bypass attempts that only become visible when analyzing how system states evolve over time.

In an embodiment, correlating the observed system states with the predefined compliance control requirements comprises calculating, for each regulated asset, a weighted compliance score derived from a plurality of rule satisfaction values corresponding to configuration state, access activity state, communication state, and protection status state, wherein determining the real-time compliance state comprises classifying the weighted compliance score into one of a plurality of discrete compliance categories stored in the non-transitory memory unit, each category being associated with an enforcement policy identifier.

In this embodiment, the compliance control apparatus converts heterogeneous system observations into a quantitative compliance metric that enables deterministic, real-time enforcement decisions. For each regulated asset, the processing unit evaluates a plurality of compliance control rules that are grouped according to operational configuration integrity, access activity behavior, communication exposure, and protection readiness. Each group produces a normalized rule satisfaction value that represents the degree to which the corresponding control requirements are met, for example whether password complexity policies are enforced, whether unauthorized remote sessions are present, whether unapproved communication ports are active, or whether intrusion detection mechanisms are enabled and functioning. These group-level values are multiplied by dynamically assigned weights that reflect the asset's functional role, criticality, and regulatory risk impact, and are then mathematically aggregated to produce a single weighted compliance score for the asset.

The weighted compliance score is then compared against a set of threshold ranges stored in the non-transitory memory unit, each range corresponding to a discrete compliance category such as “fully compliant,” “conditionally compliant,” “at risk,” or “critical violation.” Each category is explicitly linked to a predefined enforcement policy identifier that specifies the remediation workflow, notification escalation path, and isolation behavior to be applied. For example, a protective relay that falls below a critical threshold due to both configuration drift and unauthorized access attempts is automatically mapped to a high-severity enforcement policy that triggers immediate privilege revocation and network isolation, whereas a data historian server with only minor configuration deviations may be mapped to a lower-severity policy requiring scheduled remediation. This classification-driven enforcement mechanism represents a technical advancement over binary compliance flags by enabling graded, risk-aware, and automated control actions that scale across complex critical infrastructure environments while maintaining regulatory precision.

In an embodiment, evaluating compliance conditions that vary dynamically comprises: selecting a control rule set based on the asset classification and electronic security perimeter association, modifying at least one rule threshold when the bulk electric power system transitions between operating states, and re-executing the trained artificial intelligence models using the modified rule threshold without replacing the stored control rule set; wherein detecting the compliance deviation comprises: comparing the compliance state vector of a regulated asset with a baseline compliance vector stored in the non-transitory memory unit, identifying a delta vector representing non-matching parameter states, and generating a deviation event record including parameter identifiers, deviation magnitude, and deviation timestamp.

In this embodiment, the compliance control apparatus is configured to adapt its regulatory evaluation logic in real time based on both the functional role of each regulated asset and the operational context of the bulk electric power system. The processing unit first selects a relevant control rule set by referencing the asset's classification, such as substation relay, control center server, or gateway device, and its association with a defined electronic security perimeter. This ensures that only the regulatory controls applicable to that asset's risk exposure and network zone are applied. When the power system transitions between operating states—such as from normal operation to emergency load shedding, islanded operation, or scheduled maintenance—the apparatus dynamically modifies one or more rule thresholds to reflect temporary policy tolerances or heightened security requirements. For example, during a maintenance window, remote access thresholds may be temporarily relaxed, whereas during a grid emergency, communication exposure thresholds may be tightened. The trained artificial intelligence models are then re-executed using the modified thresholds while preserving the original control rule definitions, allowing adaptive compliance evaluation without rewriting or redeploying rule logic.

To detect deviations under these dynamic conditions, the system compares the real-time compliance state vector of each regulated asset with a previously stored baseline compliance vector that represents the asset's regulator-approved steady-state condition. This comparison generates a delta vector that encodes only the parameters that differ from the baseline, along with the direction and magnitude of the change. For instance, if a firewall rule count drops below the baseline or if remote login attempts exceed a defined threshold, the delta vector will reflect the exact control parameter responsible and quantify the extent of the deviation. Based on this delta representation, the apparatus generates a structured deviation event record containing the affected parameter identifiers, numerical deviation magnitude, and a synchronized timestamp. This approach provides a technical advancement by enabling context-aware, adaptive compliance monitoring that precisely isolates and quantifies violations even as regulatory thresholds change dynamically, thereby improving both detection accuracy and response reliability in complex critical infrastructure environments.

In an embodiment, generating the deviation event record further comprises linking the deviation event record to an enforcement policy identifier and storing the deviation event record in an evidence queue maintained in the non-transitory memory unit; and wherein initiating the automated compliance enforcement action comprises selecting an enforcement sequence from a plurality of stored enforcement workflows, each enforcement workflow defining an ordered set of remediation commands associated with the enforcement policy identifier; wherein selecting the enforcement sequence further comprises resolving dependencies between remediation commands by referencing an enforcement dependency table stored in the non-transitory memory unit; and wherein transmitting the verified baseline configuration data comprises segmenting the baseline configuration data into parameter groups, sequentially applying the parameter groups based on a stored application order, and validating acknowledgement responses received from the regulated asset for each parameter group.

In this embodiment, each detected deviation is not treated as an isolated alert but is converted into an actionable enforcement object by logically linking the deviation event record to a specific enforcement policy identifier that defines how the system must respond. The processing unit inserts this linked deviation record into a managed evidence queue stored in the non-transitory memory unit, where records are time-ordered and prioritized according to asset criticality and violation severity. This queue functions as a controlled execution buffer that prevents enforcement collisions, ensures ordered remediation, and enables deferred processing during high-load conditions. For example, deviations affecting protective relays inside a high-voltage substation are processed with higher priority than those affecting auxiliary monitoring servers, ensuring that enforcement resources are allocated based on operational risk.

When remediation is triggered, the apparatus selects an enforcement sequence from a library of predefined enforcement workflows, each workflow being explicitly associated with the enforcement policy identifier linked to the deviation. Each workflow is composed of an ordered set of remediation commands such as configuration restoration, access revocation, session termination, or network flow isolation. Before execution, the processing unit resolves dependencies between these commands by consulting an enforcement dependency table, which encodes prerequisite relationships to prevent unsafe execution orders. For instance, a dependency rule may require that a remote session be terminated before restoring a device configuration, or that a firewall rule be reinstated before re-enabling external communication. This dependency resolution guarantees safe, deterministic, and conflict-free remediation across complex operational environments.

To restore configuration integrity, the verified baseline configuration profile is not transmitted as a single monolithic payload but is segmented into logical parameter groups such as authentication settings, protocol enablement flags, logging policies, and network access rules. These parameter groups are sequentially applied to the regulated asset in a predefined application order stored in the non-transitory memory unit, ensuring that foundational security settings are restored before dependent operational parameters. After each group is transmitted, the regulated asset returns an acknowledgment message that includes status codes and checksum values, which are validated by the processing unit before the next group is applied. If any group fails to apply correctly, the enforcement workflow is paused or rolled back, preventing partial or inconsistent configurations. This staged and verified remediation process represents a technical advancement over conventional bulk configuration pushes by providing transactional integrity, fault isolation, and machine-verifiable enforcement across mission-critical infrastructure systems.

In an embodiment, restricting access privileges comprises generating an access revocation instruction referencing a session identifier derived from the collected session initiation records, and transmitting the access revocation instruction to the access control system for termination of an active session; wherein isolating the communication path comprises identifying a network flow associated with the regulated asset using protocol metadata extracted from the normalized internal representation and modifying traffic handling parameters specific to the identified network flow; wherein verifying effectiveness of the automated compliance enforcement action comprises re-generating the compliance state vector from the post-enforcement operational state data and re-computing the weighted compliance score for comparison with a pre-enforcement weighted compliance score; and wherein verifying further comprises storing the pre-enforcement weighted compliance score and post-enforcement weighted compliance score in the compliance evidence record.

In this embodiment, access restriction is executed with session-level precision rather than coarse user-level deactivation, thereby minimizing operational disruption while immediately neutralizing non-compliant activity. The processing unit extracts session initiation records from the normalized internal representation, which include authentication source, device identifier, timestamp, protocol type, and session token. Using this information, the system generates a targeted access revocation instruction that explicitly references the active session identifier associated with the detected deviation. This instruction is transmitted to the access control system, such as a centralized identity management server or privilege broker, which immediately terminates the corresponding session and updates its session registry to prevent re-authentication using the same credentials. For example, if an engineer's remote terminal is found to be executing unauthorized configuration changes, only that live session is forcibly closed, while legitimate sessions on other systems remain unaffected, thereby preserving operational continuity.

To contain unauthorized communications, the apparatus performs fine-grained network isolation by identifying the exact data flow associated with the non-compliant regulated asset. The processing unit extracts protocol metadata—such as source and destination addresses, service ports, application identifiers, and packet signatures—from the normalized internal representation to uniquely fingerprint the network flow. This fingerprint is used to generate a control directive for a network security device, which dynamically modifies traffic handling parameters only for that specific flow. For instance, a protective relay that begins communicating with an unapproved external endpoint can have only that unauthorized flow blocked, while supervisory control traffic to approved control center systems remains uninterrupted. This selective isolation approach technically advances traditional perimeter blocking by enabling micro-segmentation at the flow level.

After these enforcement actions are applied, the apparatus verifies remediation effectiveness by re-collecting live operational and configuration data and regenerating the compliance state representation. The processing unit re-computes the weighted compliance score using the same rule groups and weighting logic that produced the pre-enforcement score. The two scores are then compared to quantify the degree of compliance improvement. Both the pre-enforcement and post-enforcement scores are stored in the compliance evidence record along with timestamps and asset identifiers. This score-based verification mechanism provides an objective, machine-verifiable measure of enforcement success, representing a technical advancement over subjective or manual confirmation methods by enabling closed-loop, auditable compliance restoration.

In an embodiment, storing the compliance evidence record comprises generating a cryptographic hash of the compliance evidence record, associating the cryptographic hash with the time-synchronized timestamp, and storing the cryptographic hash in the non-transitory memory unit as an integrity reference; wherein storing the cryptographic hash further comprises appending the cryptographic hash to a tamper-evident sequential log maintained by the compliance control apparatus.

In this embodiment, every compliance evidence record generated by the system is cryptographically secured to ensure long-term integrity, non-repudiation, and forensic reliability. Once the compliance evidence record is assembled, including the asset identifier, deviation details, enforcement actions, and pre- and post-enforcement compliance scores, the processing unit serializes the record into a canonical data format and computes a cryptographic hash using a secure algorithm such as SHA-256 or SHA-3. This hash uniquely represents the contents of the evidence record, such that any subsequent alteration of the record would produce a different hash value. The computed hash is then bound to a trusted, time-synchronized timestamp obtained from a secure clock source and stored in the non-transitory memory unit as an integrity reference that can later be used to verify the authenticity of the evidence.

To further protect against tampering, the system appends each cryptographic hash to a sequential integrity log that is implemented as a chained data structure, where each new log entry includes the hash of the previous entry. This chaining mechanism creates a tamper-evident sequence in which any attempt to remove, reorder, or modify an entry will break the cryptographic linkage and be immediately detectable. For example, during a regulatory audit, the compliance control apparatus can recompute the hash of any stored evidence record and compare it to the corresponding log entry to mathematically prove that the record has not been altered since its creation. This cryptographically anchored evidence logging architecture represents a technical advancement over conventional audit logs by providing provable data integrity and trustworthiness for automated compliance enforcement in critical infrastructure systems.

In an embodiment, the communication interface unit maintains a persistent telemetry subscription to supervisory control and data acquisition systems and intelligent electronic devices, and wherein received telemetry values are buffered in a circular data structure prior to normalization; and wherein storing the trained artificial intelligence models comprises storing multiple model instances corresponding to distinct asset categories, and wherein executing the trained artificial intelligence models comprises dynamically selecting a model instance based on the asset category of each regulated asset.

In this embodiment, the communication interface unit establishes and maintains persistent, bidirectional telemetry subscriptions with supervisory control and data acquisition platforms and intelligent electronic devices using secure industrial protocols, enabling continuous streaming of operational measurements, status indicators, and event notifications. Rather than processing each incoming data point immediately, the interface buffers the telemetry values in a circular data structure that retains only the most recent time window of measurements for each regulated asset. As new telemetry arrives, older entries are automatically overwritten, ensuring bounded memory usage and constant-time insertion while preserving short-term temporal context. This buffering strategy allows the processing unit to absorb burst traffic during transient grid events without data loss and to normalize the telemetry in batch intervals, thereby improving throughput and reducing computational overhead during peak conditions.

In parallel, the trained artificial intelligence models are organized as multiple specialized instances, each optimized for a specific asset category such as protective relays, substation gateways, control center servers, or field sensors. When compliance evaluation is initiated, the processing unit dynamically selects the appropriate model instance by referencing the asset category metadata associated with the regulated asset. This model specialization enables the system to apply feature weighting, anomaly sensitivity, and control interpretation logic that are tailored to the operational characteristics of each asset type. For example, a relay protection model may prioritize firmware integrity and response timing, while a server model may emphasize authentication behavior and network exposure. This dynamic model selection architecture represents a technical advancement over monolithic AI engines by improving classification accuracy, reducing false positives, and enabling scalable, asset-aware compliance monitoring across heterogeneous critical infrastructure environments.

In an embodiment, normalizing the received data into the standardized internal representation comprises: parsing, by the processing unit, telemetry values, authentication events, configuration parameters, and security event attributes into discrete data objects; assigning, to each data object, a normalized field identifier selected from a compliance field dictionary stored in the non-transitory memory unit; transforming each data object into a fixed-length structured record comprising a field identifier, a data value, a data source identifier, a time-synchronized timestamp, and the unique asset identifier; storing each structured record in a time-indexed compliance datastore; and linking the structured records associated with a regulated asset into a logically ordered compliance state frame maintained in the non-transitory memory unit for execution by the trained artificial intelligence models, wherein the compliance state frame is dynamically updated by replacing only modified structured records while preserving unmodified structured records, and wherein version identifiers are incremented for each update to enable reconstruction of prior compliance states for audit replay.

In this embodiment, the compliance control apparatus implements a deterministic data standardization pipeline that converts heterogeneous operational and security data into a uniform internal structure suitable for high-speed analytics and artificial intelligence execution. The processing unit first ingests raw telemetry streams, authentication logs, configuration change events, and security alerts from disparate sources and parses them into discrete data objects, each representing a single observable system attribute or event. Every data object is then mapped to a normalized field identifier selected from a centrally maintained compliance field dictionary stored in the non-transitory memory unit. This dictionary defines a controlled vocabulary of regulatory-relevant attributes, ensuring that equivalent data points originating from different vendors or protocols are consistently interpreted by the system.

Each normalized data object is transformed into a fixed-length structured record containing the field identifier, the corresponding data value, a data source identifier, a time-synchronized timestamp, and the unique asset identifier. These records are written into a time-indexed compliance datastore that supports ordered retrieval by asset and time. For each regulated asset, the apparatus logically links the relevant structured records into a compliance state frame that represents the current operational and security posture of that asset. When new data arrives, the system performs a differential update by replacing only those structured records whose values have changed, while preserving all unmodified records. A version identifier is incremented with each update, enabling the apparatus to reconstruct any historical compliance state by replaying prior versions of the compliance state frame.

This versioned, differential data model provides a technical advancement over conventional log aggregation by enabling efficient memory usage, rapid state reconstruction, and deterministic replay for audits and forensic analysis. For example, a regulator can request the exact compliance posture of a substation gateway at a specific time in the past, and the system can reconstruct the corresponding state frame by referencing the stored versions. This architecture enables real-time AI evaluation while simultaneously supporting long-term regulatory traceability, thereby delivering both operational performance and legal evidentiary reliability.

In an embodiment, executing the trained artificial intelligence models comprises: retrieving, for a regulated asset, the corresponding compliance state frame; segmenting the compliance state frame into feature groups corresponding to configuration state, access activity state, communication state, and protection status state; applying a first internal inference stage to each feature group to generate intermediate compliance condition vectors; aggregating the intermediate compliance condition vectors into a composite compliance representation; and processing the composite compliance representation through a second internal inference stage to produce a compliance classification token representing the real-time compliance state, and wherein the intermediate compliance condition vectors include, for each predefined compliance control requirement, a control evaluation flag, a deviation magnitude parameter, and a control confidence value stored in the non-transitory memory unit.

In this embodiment, the compliance control apparatus executes the trained artificial intelligence models using a hierarchical inference architecture that mirrors the functional structure of regulatory controls. For a given regulated asset, the processing unit first retrieves the most recent compliance state frame from the non-transitory memory unit. This state frame is then segmented into logically distinct feature groups that represent the asset's configuration posture, access behavior, communication exposure, and protection readiness. Each feature group is independently processed through a first internal inference stage, which may be implemented as a neural network layer, ensemble classifier, or probabilistic model trained specifically for that control domain. This stage evaluates whether the parameters within each group satisfy the relevant regulatory requirements and outputs an intermediate compliance condition vector.

Each intermediate compliance condition vector encodes, for every applicable control requirement, a control evaluation flag indicating whether the control is satisfied, a deviation magnitude parameter quantifying the extent of any violation, and a control confidence value that reflects the model's certainty based on historical patterns and data reliability. These vectors are then aggregated by the processing unit into a composite compliance representation that captures the combined regulatory posture of the asset across all control domains. This composite representation is passed through a second internal inference stage that integrates the group-level assessments and produces a single compliance classification token representing the asset's real-time compliance state.

For example, a substation gateway may have compliant configuration and protection vectors but a non-compliant communication vector due to unauthorized outbound traffic. The aggregation layer preserves this imbalance, and the second inference stage classifies the asset as “at risk” rather than “compliant.” This multi-stage inference pipeline provides a significant technical advancement over flat rule evaluation by enabling modular, explainable, and scalable compliance reasoning, while also supporting quantitative deviation analysis and confidence scoring for regulatory decision-making

In an embodiment, correlating the observed system states with the predefined compliance control requirements further comprises dynamically selecting a compliance rule subset from a master compliance rule set based on the asset classification, the electronic security perimeter association, and the current operating state, and wherein determining the real-time compliance state comprises comparing the compliance classification token with a stored compliance state transition table that defines permissible state transitions for each regulated asset.

In this embodiment, the compliance control apparatus performs context-aware correlation by dynamically narrowing a master regulatory control library into a targeted compliance rule subset that is specific to each regulated asset. The processing unit selects this subset by jointly evaluating the asset's functional classification, its association with a defined electronic security perimeter, and the current operating state of the bulk electric power system, such as normal operation, maintenance mode, or emergency response. This contextual filtering ensures that only the controls that are technically and regulatorily relevant to the asset's present role and exposure are applied, thereby eliminating false violations caused by generic rule enforcement. For example, a protective relay inside a high-security substation zone will be evaluated using stricter communication and authentication controls than a monitoring server located in a demilitarized zone during the same operating state.

Once the trained artificial intelligence models generate a compliance classification token for the asset, the processing unit determines the real-time compliance state by comparing this token against a compliance state transition table stored in the non-transitory memory unit. This table encodes the permissible state transitions for each asset type, such as allowable transitions from “compliant” to “at risk” during a maintenance window, or prohibited transitions from “compliant”directly to “critical violation” without an intermediate warning state. If the observed transition violates the table, the system flags the condition as an abnormal compliance behavior, even if the current classification token alone appears valid. This state-transition validation mechanism provides a technical advancement over static classification by enforcing temporal and contextual consistency, thereby enabling early detection of stealthy policy bypass attempts, configuration rollback attacks, and staged intrusions in critical infrastructure environments.

In an embodiment, detecting the compliance deviation comprises: identifying, from the intermediate compliance condition vectors, at least one control evaluation flag indicating a non-satisfied compliance control requirement; generating a deviation object comprising the unique asset identifier, a control identifier, a deviation parameter value, a deviation classification, and a time-synchronized timestamp; storing the deviation object in a deviation registry maintained in the non-transitory memory unit; and associating the deviation object with an enforcement workflow identifier.

In this embodiment, the compliance control apparatus performs deviation detection by directly interrogating the intermediate compliance condition vectors produced by the first internal inference stage of the trained artificial intelligence models. The processing unit scans these vectors to identify any control evaluation flags that indicate a regulatory control requirement has not been satisfied. Once such a flag is detected, the system isolates the corresponding control identifier and extracts the associated deviation magnitude parameter, which quantifies how far the observed state diverges from the acceptable compliance threshold. Using this information, the apparatus constructs a structured deviation object that includes the unique asset identifier, the specific control identifier, the numerical deviation parameter value, a deviation classification representing severity or risk level, and a trusted, time-synchronized timestamp.

The deviation object is then stored in a deviation registry maintained in the non-transitory memory unit, where it is indexed by asset, control type, and time to enable rapid retrieval and historical trend analysis. The processing unit subsequently associates the deviation object with an enforcement workflow identifier that maps the detected violation to a predefined remediation sequence. For example, a deviation object indicating unauthorized firmware modification on a relay device is automatically linked to an enforcement workflow that includes configuration restoration, session termination, and network isolation. This object-based deviation management architecture provides a technical advancement over traditional alert systems by enabling deterministic, traceable, and automated transitions from detection to enforcement, thereby ensuring rapid and consistent compliance restoration across critical infrastructure systems.

In an embodiment initiating the automated compliance enforcement action comprises: retrieving, from the non-transitory memory unit, the enforcement workflow corresponding to the enforcement workflow identifier; decomposing the enforcement workflow into an ordered remediation command sequence; executing each remediation command only after receiving a confirmation message associated with a previously executed remediation command; and logging, for each remediation command, an execution status record including a command identifier, execution timestamp, response code, and regulated asset identifier.

In this embodiment, once a deviation object has been associated with an enforcement workflow identifier, the compliance control apparatus initiates a deterministic remediation cycle by retrieving the corresponding enforcement workflow from the non-transitory memory unit. This workflow is defined as a machine-readable policy object that encodes a sequence of remediation operations required to restore regulatory compliance for the specific type of violation. The processing unit decomposes this workflow into an ordered remediation command sequence, where each command represents a discrete technical action such as restoring configuration parameters, revoking access privileges, terminating active sessions, or modifying network security rules.

The apparatus executes the remediation commands in strict sequence, enforcing a transactional dependency model in which each command is only initiated after a confirmation message is received from the regulated asset or associated control system indicating successful completion of the preceding command. For example, a command to re-enable authentication enforcement on a gateway device must be confirmed before a subsequent command to re-open restricted communication paths is allowed to proceed. This confirmation-driven execution prevents partial remediation and ensures that the system never enters an unsafe intermediate state.

For every executed command, the processing unit generates and stores an execution status record that includes a unique command identifier, a synchronized execution timestamp, a response code indicating success or failure, and the regulated asset identifier. These records form a verifiable execution trace that allows regulators and system operators to audit exactly how and when each remediation step was applied. This sequential, confirmation-based enforcement mechanism provides a technical advancement over batch remediation approaches by delivering atomic, verifiable, and fault-tolerant compliance restoration in complex critical infrastructure environments.

In an embodiment, verifying effectiveness of the automated compliance enforcement action comprises: generating a post-enforcement compliance state frame; re-executing the trained artificial intelligence models using the post-enforcement compliance state frame; generating a post-enforcement compliance classification token; comparing the post-enforcement compliance classification token with a pre-enforcement compliance classification token; and storing both tokens in the compliance evidence record.

In this embodiment, the compliance control apparatus validates the success of each automated remediation cycle through a closed-loop verification process that is mathematically and operationally measurable. After all remediation commands in the enforcement workflow have been executed and confirmed, the processing unit immediately re-collects live telemetry, configuration parameters, access activity records, and security event data from the regulated asset. This fresh data is normalized and assembled into a post-enforcement compliance state frame that represents the asset's current operational and security posture following remediation.

The trained artificial intelligence models are then re-executed using this post-enforcement compliance state frame, following the same hierarchical inference process used during the initial evaluation. This produces a new compliance classification token that encodes the asset's real-time compliance state after corrective actions have been applied. The processing unit compares this post-enforcement token with the pre-enforcement compliance classification token that was generated when the deviation was first detected. Any difference between the two tokens is interpreted as a quantifiable measure of remediation impact, enabling the system to determine whether the asset has transitioned into an allowable compliance state or remains in violation.

Both the pre-enforcement and post-enforcement compliance classification tokens are stored together in the compliance evidence record, along with timestamps and asset identifiers, creating a verifiable before-and-after snapshot of the enforcement outcome. This token-based verification mechanism provides a significant technical advancement over manual validation and static status flags by enabling automated, repeatable, and auditable confirmation of compliance restoration across critical infrastructure systems.

In an embodiment, storing the compliance evidence record further comprises: serializing the compliance evidence record into a canonical record format; computing a cryptographic digest over the canonical record format; linking the cryptographic digest to the time-synchronized timestamp; storing the cryptographic digest in a tamper-evident evidence ledger; and linking the evidence ledger entry with the unique asset identifier and deviation object.

In this embodiment, the compliance control apparatus secures each compliance evidence record using a cryptographically verifiable persistence mechanism that ensures long-term integrity, traceability, and non-repudiation. Once the evidence record is generated, the processing unit serializes the record into a canonical format in which field order, encoding rules, and data types are standardized so that identical records always yield the same binary representation. A cryptographic digest is then computed over this canonical representation using a secure hashing algorithm, creating a unique fingerprint that mathematically binds the digest to the content of the record. This digest is linked to a trusted, time-synchronized timestamp obtained from the system clock or an external time authority, forming a verifiable temporal anchor for the evidence.

The resulting digest is written into a tamper-evident evidence ledger that is implemented as a chained or append-only data structure, where each new entry is cryptographically linked to the previous entry. This ensures that any attempt to modify, remove, or reorder stored evidence becomes immediately detectable. The ledger entry is further indexed using the unique asset identifier and the associated deviation object reference, allowing regulators, auditors, or system operators to trace every enforcement action back to the specific asset and control violation that triggered it. This cryptographically anchored ledger architecture provides a technical advancement over conventional audit logs by delivering provable data integrity, chronological trust, and end-to-end traceability for automated compliance enforcement in critical infrastructure environments.

In operation, the compliance control apparatus is initialized by loading, from the non-transitory memory unit, trained artificial intelligence models, asset classification data, baseline configuration profiles, and predefined compliance control requirements applicable to regulated assets within the bulk electric power system. During initialization, the processing unit establishes secure communication sessions through the communication interface unit with supervisory control and data acquisition systems, intelligent electronic devices, authentication servers, network security devices, and configuration repositories. The processing unit also synchronizes its internal clock with a trusted time source to ensure that all subsequent events, evaluations, and evidence records are associated with time-synchronized timestamps suitable for audit and forensic analysis.

Once initialized, the processing unit continuously receives real-time operational state data from field and control assets, including telemetry values, status indicators, control command activity, and protection state transitions. In parallel, the processing unit receives access activity data comprising authentication attempts, authorization decisions, session initiation and termination events, and user identity attributes associated with both local and remote access to regulated assets. Configuration state data reflecting firmware versions, parameter values, communication settings, and security-relevant options is also received either through periodic polling or event-driven notifications. Security event data originating from network monitoring devices and host-based security controls is concurrently ingested. All received data streams are accepted without interrupting primary power system operations and are buffered within the non-transitory memory unit for processing.

The processing unit executes a normalization technique that converts heterogeneous data formats into a standardized internal representation. This normalization technique parses device-specific logs, protocol messages, and configuration structures, extracts compliance-relevant attributes, and maps them to a common schema. The standardized representation enables uniform analysis across heterogeneous asset types, including legacy devices, embedded controllers, and modern digital protection equipment. The normalization process further associates each data element with an asset identifier, asset category, and electronic security perimeter association derived from stored asset classification data.

Following normalization, the processing unit executes the trained artificial intelligence models to evaluate compliance. The models are configured to correlate observed system states with predefined compliance control requirements while accounting for contextual variables such as asset criticality designation, operational role within the bulk electric power system, and current operating state, including normal, maintenance, or emergency conditions. The artificial intelligence models analyze temporal sequences of events rather than isolated data points, enabling detection of compliance deviations that manifest only through event correlation, such as unauthorized configuration changes occurring during otherwise authorized access sessions or repeated short-duration access attempts that cumulatively exceed permitted thresholds.

Based on the output of the artificial intelligence models, the processing unit computes a real-time compliance state for each regulated asset. The compliance state reflects whether all applicable compliance control requirements are satisfied, partially satisfied, or violated. When the compliance state indicates a violation or an imminent risk of violation, the processing unit identifies the specific control requirement that is not satisfied and determines an appropriate enforcement action based on stored enforcement policies. Enforcement actions are selected techniqueically by evaluating the type of deviation, asset criticality, and operational impact constraints to ensure that compliance restoration does not compromise grid stability.

Upon selection of an enforcement action, the processing unit initiates the action through the communication interface unit. For configuration-related deviations, the processing unit retrieves verified baseline configuration data from the non-transitory memory unit and transmits the data to the affected asset to restore the asset to a compliant configuration state. For access-related deviations, the processing unit transmits updated authorization control data to the access control system to restrict or revoke access privileges. For network-related deviations, the processing unit transmits control instructions to a network security device to isolate or modify communication paths associated with the non-compliant asset. Each enforcement action is executed in a controlled manner to avoid unintended disruption of essential power system functions.

After execution of an enforcement action, the processing unit performs a verification step by re-collecting operational state data and configuration state data from the affected asset. The processing unit re-executes the trained artificial intelligence models on the post-enforcement data to confirm that the predefined compliance control requirements are now satisfied. If the verification indicates that compliance has not been fully restored, the processing unit may initiate additional enforcement actions or escalate the condition through compliance alerts transmitted to supervisory systems.

Concurrently with compliance evaluation and enforcement, the processing unit generates compliance evidence records. Each evidence record binds the detected compliance deviation, the executed enforcement action, and the verification result to a time-synchronized timestamp and a unique asset identifier. The evidence records are stored in a write-protected sequence within the non-transitory memory unit such that any modification or deletion of previously stored records is detectable. This evidentiary structure ensures that compliance documentation accurately reflects actual system behavior over time and can be directly used for audit and regulatory reporting purposes.

The processing unit further executes a predictive analysis technique by applying the trained artificial intelligence models to historical compliance states, access behavior patterns, configuration change frequency data, and system topology evolution data stored in the non-transitory memory unit. The predictive technique identifies trends and patterns indicative of emerging non-compliance risks and generates forecasted non-compliance indicators corresponding to future operational time intervals. When a forecasted indicator exceeds a predefined risk threshold, the processing unit initiates preventive compliance enforcement actions, such as preemptive configuration validation or access restriction, thereby reducing the likelihood of future compliance violations.

In embodiments where multiple compliance control apparatuses are deployed across different physical locations, the processing unit periodically synchronizes compliance states and compliance evidence records with peer apparatuses through secure communication channels. During periods of communication loss, each apparatus maintains autonomous compliance enforcement capability using locally stored data. Upon restoration of communication, synchronization techniques reconcile compliance evidence records while preserving the integrity and chronological order of stored data. Through this continuous, context-aware, and automated process, the invention achieves real-time, enforceable, and auditable Critical Infrastructure Protection compliance within bulk electric power systems.

The Artificial Intelligence-Driven Automation System for Critical Infrastructure Protection Compliance in Bulk Electric Power Systems is embodied as a dedicated machine-based apparatus comprising a secured enclosure housing a processing assembly, a memory assembly, a communication interface assembly, and a power conditioning assembly, all structurally integrated to operate within substation environments, control centers, or data aggregation points of bulk electric power systems. The apparatus is configured for continuous operation under high-availability requirements and is electrically isolated to withstand electromagnetic interference, voltage transients, and environmental conditions typical of power system infrastructure.

The processing assembly comprises one or more industrial-grade processors configured to execute artificial intelligence inference operations, compliance rule evaluation routines, and enforcement logic. The processors are coupled to a non-transitory memory assembly storing trained machine learning models, compliance knowledge representations, regulatory control mappings, historical compliance states, and system-specific asset profiles. The memory assembly further stores cryptographically protected audit records and compliance evidence in a tamper-resistant format.

The communication interface assembly includes multiple secure communication ports configured to interface with supervisory control and data acquisition systems, energy management systems, intelligent electronic devices, network security appliances, access control servers, and configuration management repositories. The apparatus is capable of ingesting structured and unstructured data streams, including operational telemetry, authentication events, firmware status information, network flow metadata, and physical access logs, without disrupting primary power system operations.

During operation, the apparatus continuously receives data reflecting the real-time operational state of bulk electric power assets and processes such data through artificial intelligence models trained to recognize compliance-relevant patterns, deviations, and contextual dependencies. The artificial intelligence models dynamically correlate asset behavior, access activities, configuration changes, and communication patterns with predefined Critical Infrastructure Protection compliance controls. The system evaluates whether observed states satisfy mandatory compliance conditions, temporal constraints, and procedural safeguards, and assigns a continuously updated compliance state to each monitored asset and subsystem.

In response to detecting a compliance deviation or a predicted risk of non-compliance, the apparatus autonomously initiates enforcement actions through its communication interface assembly. Such actions include transmitting commands to restrict or revoke access privileges, isolating affected network segments, triggering configuration restoration to a known compliant state, or escalating alerts to designated operators with contextualized compliance impact information. The apparatus records each detected event, evaluated condition, and enforcement action in its memory assembly, generating immutable compliance evidence suitable for regulatory audits.

The system further incorporates predictive analytics capabilities wherein the artificial intelligence models analyze historical trends, usage patterns, and operational changes to forecast potential future compliance violations before they occur. This predictive function enables proactive remediation, allowing operators to address emerging risks without waiting for an actual compliance breach. The apparatus continuously adapts its models through controlled learning processes based on verified outcomes, system updates, and regulatory revisions, thereby maintaining alignment with evolving compliance standards.

Structurally, the apparatus is designed as a self-contained compliance control unit mountable within standard industrial racks or protective enclosures. The enclosure includes thermal management elements, electromagnetic shielding, and physical tamper detection mechanisms that generate alerts upon unauthorized physical interaction. Power is supplied through redundant power inputs with surge protection and battery-backed operation to ensure uninterrupted compliance monitoring during power disturbances.

The apparatus may be deployed as a single unit or as part of a distributed architecture wherein multiple devices operate in coordinated fashion across geographically dispersed bulk electric power system locations. In such configurations, the devices securely synchronize compliance states, enforcement actions, and evidentiary records to maintain a consistent system-wide compliance posture while preserving localized autonomy.

By integrating artificial intelligence-driven analysis, automated enforcement, and continuous evidence generation into a dedicated machine-based structure, the present invention transforms Critical Infrastructure Protection compliance from a reactive, manual process into an autonomous, real-time operational function embedded directly within bulk electric power systems. The invention thereby enhances security, reduces compliance overhead, improves audit readiness, and strengthens the overall resilience of critical electric infrastructure.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for artificial intelligence-driven automation of critical infrastructure protection compliance in bulk electric power systems, the method being executed by a compliance control apparatus comprising at least one processing unit, a non-transitory memory unit, and a communication interface unit, the method comprising:
receiving, by the processing unit through the communication interface unit, real-time operational state data, access activity data, configuration state data, and security event data from a plurality of regulated assets and supporting systems within a bulk electric power system;
storing, in the non-transitory memory unit, trained artificial intelligence models encoding predefined compliance control requirements applicable to the regulated assets together with asset classification data and baseline configuration data;
normalizing, by the processing unit, the received data into a standardized internal representation to enable uniform evaluation across heterogeneous asset types;
executing, by the processing unit, the trained artificial intelligence models to correlate observed system states with the predefined compliance control requirements while accounting for asset category, asset criticality designation, association with an electronic security perimeter, and a current operating state of the bulk electric power system;
determining, by the processing unit, a real-time compliance state for each regulated asset based on the correlation;
detecting, by the processing unit, a compliance deviation when the determined real-time compliance state fails to satisfy at least one predefined compliance control requirement;
initiating, by the processing unit through the communication interface unit, an automated compliance enforcement action in response to the detected compliance deviation;
verifying, by the processing unit, effectiveness of the automated compliance enforcement action by re-evaluating a post-enforcement operational state of the regulated asset against the predefined compliance control requirements; and
storing, in the non-transitory memory unit, a compliance evidence record binding the detected compliance deviation, the automated compliance enforcement action, and the verification result to a time-synchronized timestamp and a unique asset identifier, wherein receiving the real-time operational state data comprises acquiring telemetry values, protection status indicators, and control command activity from supervisory control and data acquisition systems and intelligent electronic devices without interrupting primary power system operations, wherein receiving the access activity data comprises collecting authentication events, authorization attributes, session initiation records, session termination records, and user identity information associated with interactive and remote access to regulated assets, and wherein normalizing the received data comprises converting device-specific log formats, protocol representations, and configuration parameter structures into a common internal data structure stored in the non-transitory memory unit prior to execution of the trained artificial intelligence models.

2. The method of claim 1, wherein executing the trained artificial intelligence models comprises evaluating compliance conditions that vary dynamically based on changes in asset classification, changes in electronic security perimeter boundaries, and transitions between normal, maintenance, and emergency operating states, and wherein detecting the compliance deviation comprises identifying a configuration parameter of a regulated asset that deviates from a stored baseline configuration profile maintained in the non-transitory memory unit.

3. The method of claim 1, wherein initiating the automated compliance enforcement action comprises transmitting verified baseline configuration data from the non-transitory memory unit to the regulated asset through the communication interface unit to restore the regulated asset to a compliant configuration state, wherein initiating the automated compliance enforcement action comprises restricting access privileges by transmitting updated authorization control data to an access control system associated with the bulk electric power system, wherein initiating the automated compliance enforcement action comprises isolating a communication path by instructing a network security device to modify traffic handling parameters associated with a regulated asset identified as non-compliant, and wherein verifying effectiveness of the automated compliance enforcement action comprises re-collecting operational state data and configuration state data from the regulated asset and re-executing the trained artificial intelligence models to confirm satisfaction of the predefined compliance control requirements.

4. The method of claim 1, wherein normalizing the received data comprises: mapping telemetry values, access activity records, configuration parameters, and security event fields into a multi-dimensional compliance state vector, assigning each element of the compliance state vector a semantic label corresponding to a predefined compliance control requirement, associating each element with the unique asset identifier, asset category, and asset criticality designation, and persisting the compliance state vector in the non-transitory memory unit for time-sequenced correlation by the trained artificial intelligence models.

5. The method of claim 4, wherein normalizing further comprises generating a versioned compliance snapshot by time-aligning the compliance state vector with the time-synchronized timestamp, and storing successive compliance snapshots in a chronological compliance state graph representing temporal transitions of each regulated asset, and wherein executing the trained artificial intelligence models comprises traversing the chronological compliance state graph to evaluate transitions between successive compliance snapshots against control transition rules stored in the non-transitory memory unit.

6. The method of claim 1, wherein correlating the observed system states with the predefined compliance control requirements comprises calculating, for each regulated asset, a weighted compliance score derived from a plurality of rule satisfaction values corresponding to configuration state, access activity state, communication state, and protection status state, wherein determining the real-time compliance state comprises classifying the weighted compliance score into one of a plurality of discrete compliance categories stored in the non-transitory memory unit, each category being associated with an enforcement policy identifier.

7. The method of claim 2, wherein evaluating compliance conditions that vary dynamically comprises: selecting a control rule set based on the asset classification and electronic security perimeter association, modifying at least one rule threshold when the bulk electric power system transitions between operating states, and re-executing the trained artificial intelligence models using the modified rule threshold without replacing the stored control rule set; wherein detecting the compliance deviation comprises: comparing the compliance state vector of a regulated asset with a baseline compliance vector stored in the non-transitory memory unit, identifying a delta vector representing non-matching parameter states, and generating a deviation event record including parameter identifiers, deviation magnitude, and deviation timestamp.

8. The method of claim 1, wherein generating the deviation event record further comprises linking the deviation event record to an enforcement policy identifier and storing the deviation event record in an evidence queue maintained in the non-transitory memory unit; and wherein initiating the automated compliance enforcement action comprises selecting an enforcement sequence from a plurality of stored enforcement workflows, each enforcement workflow defining an ordered set of remediation commands associated with the enforcement policy identifier; wherein selecting the enforcement sequence further comprises resolving dependencies between remediation commands by referencing an enforcement dependency table stored in the non-transitory memory unit; and wherein transmitting the verified baseline configuration data comprises segmenting the baseline configuration data into parameter groups, sequentially applying the parameter groups based on a stored application order, and validating acknowledgement responses received from the regulated asset for each parameter group.

9. The method of claim 3, wherein restricting access privileges comprises generating an access revocation instruction referencing a session identifier derived from the collected session initiation records, and transmitting the access revocation instruction to the access control system for termination of an active session; wherein isolating the communication path comprises identifying a network flow associated with the regulated asset using protocol metadata extracted from the normalized internal representation and modifying traffic handling parameters specific to the identified network flow; wherein verifying effectiveness of the automated compliance enforcement action comprises re-generating the compliance state vector from the post-enforcement operational state data and re-computing the weighted compliance score for comparison with a pre-enforcement weighted compliance score; and wherein verifying further comprises storing the pre-enforcement weighted compliance score and post-enforcement weighted compliance score in the compliance evidence record.

10. The method of claim 1, wherein storing the compliance evidence record comprises generating a cryptographic hash of the compliance evidence record, associating the cryptographic hash with the time-synchronized timestamp, and storing the cryptographic hash in the non-transitory memory unit as an integrity reference; wherein storing the cryptographic hash further comprises appending the cryptographic hash to a tamper-evident sequential log maintained by the compliance control apparatus.

11. The method of claim 1, wherein the communication interface unit maintains a persistent telemetry subscription to supervisory control and data acquisition systems and intelligent electronic devices, and wherein received telemetry values are buffered in a circular data structure prior to normalization; and wherein storing the trained artificial intelligence models comprises storing multiple model instances corresponding to distinct asset categories, and wherein executing the trained artificial intelligence models comprises dynamically selecting a model instance based on the asset category of each regulated asset.

12. The method of claim 1, wherein normalizing the received data into the standardized internal representation comprises: parsing, by the processing unit, telemetry values, authentication events, configuration parameters, and security event attributes into discrete data objects; assigning, to each data object, a normalized field identifier selected from a compliance field dictionary stored in the non-transitory memory unit; transforming each data object into a fixed-length structured record comprising a field identifier, a data value, a data source identifier, a time-synchronized timestamp, and the unique asset identifier; storing each structured record in a time-indexed compliance datastore; and linking the structured records associated with a regulated asset into a logically ordered compliance state frame maintained in the non-transitory memory unit for execution by the trained artificial intelligence models, wherein the compliance state frame is dynamically updated by replacing only modified structured records while preserving unmodified structured records, and wherein version identifiers are incremented for each update to enable reconstruction of prior compliance states for audit replay.

13. The method of claim 1, wherein executing the trained artificial intelligence models comprises: retrieving, for a regulated asset, the corresponding compliance state frame; segmenting the compliance state frame into feature groups corresponding to configuration state, access activity state, communication state, and protection status state; applying a first internal inference stage to each feature group to generate intermediate compliance condition vectors; aggregating the intermediate compliance condition vectors into a composite compliance representation; and processing the composite compliance representation through a second internal inference stage to produce a compliance classification token representing the real-time compliance state, and wherein the intermediate compliance condition vectors include, for each predefined compliance control requirement, a control evaluation flag, a deviation magnitude parameter, and a control confidence value stored in the non-transitory memory unit.

14. The method of claim 1, wherein correlating the observed system states with the predefined compliance control requirements further comprises dynamically selecting a compliance rule subset from a master compliance rule set based on the asset classification, the electronic security perimeter association, and the current operating state, and wherein determining the real-time compliance state comprises comparing the compliance classification token with a stored compliance state transition table that defines permissible state transitions for each regulated asset.

15. The method of claim 1, wherein detecting the compliance deviation comprises: identifying, from the intermediate compliance condition vectors, at least one control evaluation flag indicating a non-satisfied compliance control requirement; generating a deviation object comprising the unique asset identifier, a control identifier, a deviation parameter value, a deviation classification, and a time-synchronized timestamp; storing the deviation object in a deviation registry maintained in the non-transitory memory unit; and associating the deviation object with an enforcement workflow identifier.

16. The method of claim 3, wherein initiating the automated compliance enforcement action comprises: retrieving, from the non-transitory memory unit, the enforcement workflow corresponding to the enforcement workflow identifier; decomposing the enforcement workflow into an ordered remediation command sequence; executing each remediation command only after receiving a confirmation message associated with a previously executed remediation command; and logging, for each remediation command, an execution status record including a command identifier, execution timestamp, response code, and regulated asset identifier.

17. The method of claim 3, wherein verifying effectiveness of the automated compliance enforcement action comprises: generating a post-enforcement compliance state frame; re-executing the trained artificial intelligence models using the post-enforcement compliance state frame; generating a post-enforcement compliance classification token; comparing the post-enforcement compliance classification token with a pre-enforcement compliance classification token; and storing both tokens in the compliance evidence record.

18. The method of claim 1, wherein storing the compliance evidence record further comprises: serializing the compliance evidence record into a canonical record format; computing a cryptographic digest over the canonical record format; linking the cryptographic digest to the time-synchronized timestamp; storing the cryptographic digest in a tamper-evident evidence ledger; and linking the evidence ledger entry with the unique asset identifier and deviation object.
